(19) United States
(12) Patent Application Publication
(10) Pub. No.: US 2026/0236988 A1
(43) Pub. Date: Aug. 13, 2026

(54) AGENTIC ARTIFICIAL INTELLIGENCE ARCHITECTURE FOR CROSS-EXCHANGE SECURITY

(71) Applicant: Bank of America Corporation, Charlotte, NC (US)

(72) Inventors: Laxma Reddy Gavinolla, Hyderabad (IN); Pinky Panwar, Gandhidham (IN); Meenu Goyal, Bagha Purana (IN); Durga Prasad Kutthumolu, Hyderabad (IN)

(21) Appl. No.: 19/051,852

(22) Filed: Feb. 12, 2025

(51) Int. Cl. G06Q 40/04; G06F 21/62; G06Q 20/06; G06Q 20/38; G06Q 30/0282

(52) U.S. Cl. CPC G06Q 40/04; G06F 21/6227; G06Q 20/06; G06Q 20/3829; G06Q 30/0282

(57) ABSTRACT

Systems, methods, and apparatus are provided for an agentic AI architecture for cross-exchange security. An application programming interface (API) may include a set of AI agents. A first AI agent may manage access to a universal cryptocurrency identifier system. In response to a trade request at a first exchange, a second AI agent may optimize and execute a query on the universal cryptocurrency identifier system to return a compatible trade partner. The second AI agent may optimize and execute a query at a second exchange and output a security level for each partner. A third AI agent may interface with the trade partners and with the exchanges to execute transfers and manage communications. The set of agents may interact and operate cooperatively to establish access, manage risks, resolve disputes, and correct technical malfunctions.

### FIELD OF TECHNOLOGY

Aspects of the disclosure relate to security of a crypto-currency exchange.

### BACKGROUND OF THE DISCLOSURE

A cryptocurrency exchange enables customers to trade digital currencies for other assets, such as conventional fiat money or other digital currencies. A decentralized exchange enables direct peer-to-peer cryptocurrency transactions without the need for an intermediary. In transactions through a decentralized exchange, transaction security and asset transfer may be managed by a distributed ledger such as a blockchain or by any suitable system. Asset transfers may be effected through the user of smart contracts or via any suitable method.

A decentralized exchange may be more anonymous than a centralized exchange mediated by a financial institution bound by Know Your Customer (KYC) regulatory requirements. This anonymity may make it challenging to verify the identity of a trading partner and ensure that the assets being exchanged are legitimate.

Moreover, each cryptocurrency exchange may use different token formats and authentication protocols, making it challenging to verify the identity of a trading partner across different exchanges.

Agentic artificial intelligence (AI) is an advanced form of artificial intelligence capable of taking independent action in complex environments. Agentic AI systems may analyze options, predict outcomes, and respond to challenges in real time.

Agentic AI architecture may integrate specialized agents each designed for a specific purpose. In a multi-agent system, multiple independent agents may collaborate to manage complex tasks. Each agent may be powered by a large language model. Reinforcement learning may enable the agents to dynamically evolve based on feedback from interactions with their environments.

It would be desirable to use agentic AI architecture that integrates multiple AI agents to identify and authenticate trading partners for cross-exchange transactions.

### SUMMARY OF THE DISCLOSURE

Systems, methods, and apparatus are provided for an agentic AI architecture for cross-exchange security.

An application programming interface (API) may include a set of AI agents. A first AI agent may use a hash function to generate a universal cryptocurrency identifier (UCI) associated with a buyer or seller public address. The first AI agent may store the UCI in a decentralized database and may manage UCI access.

A second AI agent may extract information from a trade request and generate a query based on predicted trade parameters. The second AI agent may interface with the first AI agent to query the UCI database and return a UCI and public address for a compatible seller.

The second AI agent may generate a query for an exchange associated with the seller. The query may return past activity by the seller. The query may return backend log data for the past activity. The query may be optimized based on the exchange structure. Based on the query results, the second AI agent may output a security level for the seller.

A third AI agent may interface with a cryptocurrency exchange associated with the buyer and cryptocurrency exchanges associated with the seller. The third AI agent may deploy the second AI agent at the seller and/or buyer exchanges. In some embodiments, the third AI agent may execute the query at the seller and/or buyer exchange. The third AI agent may provide guidance to the second AI agent to optimize the query. The guidance may be based on exchange structure, node telemetry, or any suitable factors.

The third AI agent may interface with the buyer and the seller. The third AI agent may display a list of sellers and security levels generated by the second AI agent. The third AI agent may recommend a seller from the list based on the trade parameters, seller security level, exchange security features, or any suitable factors.

The third AI agent may generate a set of actions that mitigate a security level associated with a seller. The security level may be below a predetermined threshold. The third AI agent may display the actions to the buyer.

The third AI agent may receive inputs from the buyer and the seller and, in response, initiate a cryptocurrency transfer. Initiating the cryptocurrency transfer may include generating a smart contract. The smart contract may include the risk mitigation actions. Executing the transfer may include executing the smart contract.

The third AI agent may confirm execution of the transfer with the buyer cryptocurrency exchange and the seller cryptocurrency exchange. The third AI agent may confirm execution of the transfer with the buyer and seller.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus in accordance with principles of the disclosure;

FIG. 2 shows illustrative apparatus in accordance with principles of the disclosure;

FIG. 3 shows an illustrative process flow in accordance with principles of the disclosure; and

FIG. 4 shows an illustrative process flow in accordance with principles of the disclosure.

### DETAILED DESCRIPTION

Systems, methods, and apparatus are provided for agentic AI architecture for cross-exchange security.

For the sake of illustration, the invention will be described as being performed by a “system.” The system may include one or more features of apparatus and methods that are described herein and/or any other suitable device or approach.

Peer-to-peer (P2P) cryptocurrency transactions may be carried out at an exchange platform that enables buyers and sellers to interact. P2P platforms may provide users with direct control over their transactions and may allow for more flexible payment methods and lower fees than a traditional exchange.

However, the decentralized nature of P2P exchanges and the many proprietary formats raise several challenges. One challenge for buyers may involve locating a seller. It may be difficult for a buyer to evaluate the differences between sellers and to determine the most optimal match. Another challenge for buyers may involve verifying the identity of a seller and ensuring that the seller is a legitimate actor. Each exchange may have proprietary verification methods with differing levels of rigor. For example, an exchange may accept digital wallet credentials from a seller at face value, leaving the transaction vulnerable to a bad actor who has misappropriated those credentials.

The system may deploy multiple AI agents that collaborate to locate a compatible buyer or seller and verify identity across exchange formats. Each agent may be powered by a large language model. Reinforcement learning may enable the agents to dynamically evolve based on feedback from interactions with their environments.

The system may include an application programing interface (API). The API may include the suite of AI agents. The API may be associated with a financial institution. The financial institution may be a bank, a brokerage firm, or any suitable entity. A financial institution customer may interface with the financial institution to buy, sell, or trade cryptocurrency. The customer may interface with the financial institution at a mobile device application, an internet portal, by telephone, or via any suitable method. The financial institution may activate the API on behalf of the customer to locate a cryptocurrency buyer or seller and verify the identity of the parties.

The system may include a first AI agent. The first AI agent may generate a universal cryptocurrency identifier (UCI) for the buyer or seller. The first AI agent may be activated in response to a trade request, registration with a financial institution, registration with an exchange, or at any suitable time. The first AI agent may use a hashing function or any suitable encryption method to generate a unique UCI.

The UCI may be associated with a digital wallet public address. The UCI may be associated with multiple public addresses. The public address may be associated with a cryptocurrency system. The public address may be encrypted from a public key generated by the cryptocurrency system. The public address may enable a user to receive, view, and verify cryptocurrency transactions on a decentralized network.

The first AI agent may store the UCI in a decentralized database or in any suitable storage system. The first AI agent may manage access to the UCI database. The UCI may be stored with encrypted links to the public addresses. The UCI may provide an additional layer of security. Even if digital wallet credentials were to be misappropriated by a bad actor, the bad actor may not have access to the UCI.

The system may include a second AI agent. The second AI agent may access a request received by the financial institution from a buyer or seller. For example, the request may be received from a buyer interested in purchasing a particular type and amount of cryptocurrency. The request may include a UCI associated with the buyer.

The second AI agent may generate a query that includes transaction parameters. The second AI agent may extract transaction parameters from a request received by the financial institution. The second AI agent may include a large language model configured to generate the query from a natural language prompt.

In some embodiments, the second AI agent may predict transaction details for the buyer. The prediction may be based on the UCI associated with the buyer. The UCI may be extracted from the buyer request. The second AI agent may retrieve transaction parameters from a cryptocurrency exchange associated with the financial institution based on this prediction. The second AI agent may retrieve transaction parameters from a cryptocurrency exchange associated with a buyer. In some embodiments, the transaction details may be specific to the buyer and may be based on buyer history. In some embodiments, the second AI agent may optimize transaction details based on other transactions involving similar parameters.

The second AI agent may query the UCI database to identify compatible sellers. Compatibility may be based on the transaction parameters or on any suitable factors. The query may return links to public addresses associated with a seller.

In some embodiments, the first AI agent may establish access for the second AI agent at the UCI database. In some embodiments, the first AI agent may execute the query generated by the second AI agent and return UCIs and links for compatible sellers to the second AI agent.

A third AI agent may manage interactions with the buyer, seller, and with any exchanges associated with the public address links. The third AI agent may interface with an exchange associated with the seller. The second AI agent may access an exchange platform via the interface. In some embodiments the third AI agent may execute the query generated by the second AI agent at the exchange.

In some cases, a seller with a bad history on one exchange may switch to a different exchange. The third AI agent may interface with multiple exchanges to help the second AI agent trace the party through multiple smart contracts to track transaction history.

The third AI agent may guide the second AI agent based on information about an exchange or a network. For example, the third AI agent may receive information from a network node. The third AI agent may provide input to the second AI agent regarding features to be investigated. The third AI agent may provide input to the second AI agent for optimizing the query.

The second AI agent may generate a query directed to past seller activity on the exchange. The second AI agent may identify past activity by the seller. The second AI agent may flag risks associated with past activity. The risks may be associated with the amounts of past transactions, frequency of past transactions, past transaction partners, and/or any suitable factors. The risks may be associated with typical patterns of bad actors and may be based on discrepancies with the current transaction in timing, location, device metadata, and/or any suitable discrepancies. The risks may be associated with exchange security parameters.

The second AI agent may query backend technical components to determine suspicious activity. For example, inputs to the second AI agent may include timestamps from real time banking activity. Inputs may include indications of attempts to work around transaction limits such as multiple transactions in a short period. Inputs may include device metadata that indicates an advanced device typically used by bad actors to evade detection. Inputs may include cookies or a backend portal certificate that may indicate or rule out a dark web connection.

The second AI agent may act independently to optimize queries. The optimization may include any suitable tuning operations to improve speed, efficiency, and accuracy, including adjusting indexing, joins, aggregation, and concurrency. The second AI agent may use a Naive Bayes classification algorithm or any suitable algorithm to optimize a query based on transaction parameters. The second AI agent may use an elastic search algorithm or any suitable search algorithm to query the decentralized UCI database for links to public addresses of compatible buyers.

The second AI agent may return a set of sellers that are compatible with the buyer request. The second AI agent may return a set of risks and/or a security level associated with each seller. The security level may be based on the set of risks and may be determined using any suitable metric.

The third AI agent may interface with the buyer. In some embodiments, the interface with the buyer may be mediated by the financial institution. The third AI agent may interface with the buyer at a portal associated with the financial institution. The third AI agent may present the set of sellers. The third AI agent may rank the set of sellers based on the parameters of the transaction. The third AI agent may rank the sellers based on their security levels. The third AI agent may recommend a seller from the set of sellers to the buyer based on a balance of factors.

The third AI agent may recommend a set of actions to mitigate risks associated with a seller, a transaction, or an exchange. The recommendation may be triggered by a security level below a predetermined threshold. Illustrative actions may include requiring funds to be placed in escrow or requiring the seller to carry out the transaction at a different exchange with stronger security requirements. The third AI agent may receive input from a buyer and/or seller selecting a mitigation action. In some embodiments, the third AI agent may implement the mitigation actions without obtaining approval.

The third AI agent may act independently to remove transaction obstacles. For example, in the case of a network disruption while the cryptocurrency system is processing the transaction, the third AI agent may help restore the transaction from the initial stage or may roll back the transaction. The third AI agent may provide dispute resolution between the buyer and seller. The third AI agent may provide dispute resolution between a party and an exchange.

In some embodiments, in response to approval by the buyer, the seller may initiate a cryptocurrency transaction. The seller may use a private key to generate a digital signature which is verified by the cryptocurrency network. In some embodiments, the third AI agent may initiate the cryptocurrency transaction on behalf of the seller.

In some embodiments, in response to approval by the buyer, the buyer may initiate the cryptocurrency transaction. In some embodiments, the financial institution may initiate the transaction on behalf of the buyer. The seller may use a private key to generate a digital signature which is verified by the cryptocurrency network. In some embodiments, the third AI agent may initiate the cryptocurrency transaction on behalf of the seller.

The cryptocurrency system may generate a smart contract that conforms to the buyer parameters. The cryptocurrency system may execute the smart contract to complete the transaction. In some embodiments the third AI agent may review and amend the smart contract. In some embodiments, the third AI agent may generate a smart contract. The third AI agent may generate a smart contract that includes one or more risk mitigation actions.

The third AI agent may interface with the cryptocurrency system to confirm execution of the transaction. The third AI agent may communicate with an exchange associated with the buyer and an exchange associated with the seller to confirm execution of the transaction. The third AI agent may verify receipt of the funds at the buyer public address. The third AI agent may communicate with the buyer and the seller to confirm execution of the transaction.

The AI agents may include reinforcement learning. The system may access data regarding failed transactions and/or parties subsequently identified as bad actors. The AI agents may use this feedback to refine and improve their AI models. Data may be obtained from exchanges, financial institutions, news feeds, internet searches, buyer or seller reviews, or any suitable source of feedback. Data may be incorporated into training sets, be applied to adjust weights, and/or applied in any suitable way to tune the agentic AI models.

One or more non-transitory computer-readable media storing computer-executable instructions are provided. When executed by a processor on a computer system, the instructions may perform a method for secure cross-exchange interaction. The method may include initiating an API comprising a set of AI agents.

The method may include, using a hash function, generating a first universal cryptocurrency identifier (UCI) for a buyer, the UCI associated with a first public address, and storing the first UCI in a decentralized database in association with the first public address.

The method may include, using the hash function, generating a second UCI for a seller, the UCI associated with a second public address, and storing the second UCI in the decentralized database in association with the second public address.

The method may include at a first cryptocurrency exchange, extracting the first UCI from a buyer request. The method may include generating a query based on predicted trade parameters, the trade parameters based at least in part on the first UCI.

The method may include executing the query at the decentralized database and retrieving the second UCI and second public address. The query may be optimized for the decentralized database.

The method may include executing the query at a second cryptocurrency exchange and retrieving past activity associated with the second UCI. The query may be optimized for the second cryptocurrency exchange. The method may include, based on the past activity at the second cryptocurrency exchange, outputting a security level associated with the seller. The security level may be based, at least in part, on metadata associated with a seller device, on a seller location, or on any suitable factors.

The method may include generating a ranked list of sellers based at least in part on the security levels for each seller.

The method may include outputting a set of actions based a security level associated with a seller and, in response to input from a buyer selecting the seller, implementing the set of actions.

The method may include interfacing with the buyer at the first cryptocurrency exchange and the seller at the second cryptocurrency exchange.

The method may include displaying a set of sellers and associated security levels to the buyer. The method may include, in response to input by the buyer selecting a seller, initiating a cryptocurrency transfer using a private key.

The method may include generating a smart contract that includes a buyer specification and/or an action selected by the seller from the set of actions based on the security level associated with the seller. Execution of the cryptocurrency transfer may include execution of the smart contract.

The method may include in response to execution of the cryptocurrency transfer, confirming execution of the transaction to the buyer and the first cryptocurrency exchange and confirming execution of the transfer to the seller and the second cryptocurrency exchange.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods. Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

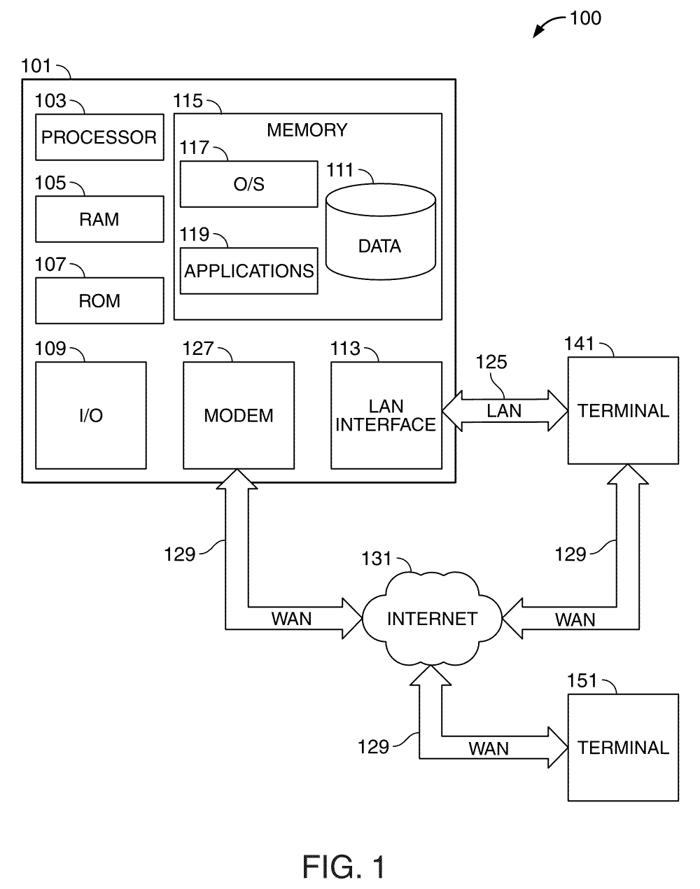

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute all software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

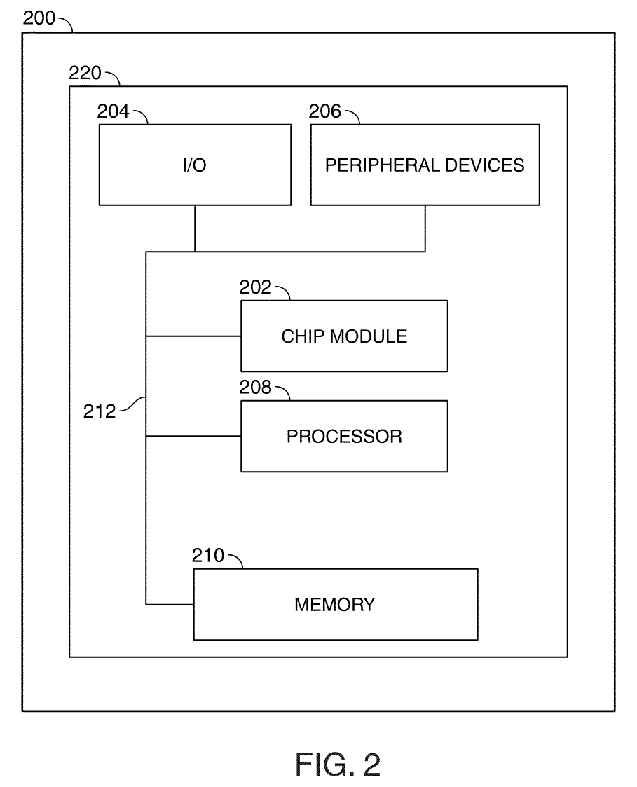

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

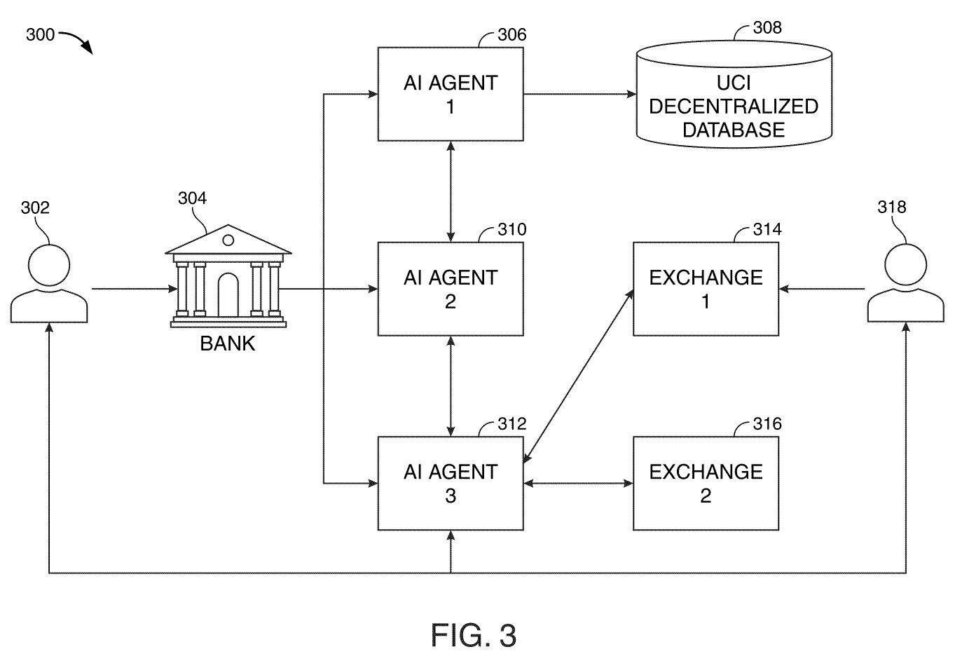

FIG. 3 shows illustrative process flow 300 for agentic AI architecture for securing cross-exchange activity. Buyer 302 may be a client of bank 304. Buyer 302 may interact with bank 304. Bank 304 may implement an API that includes a suite of AI agents. A first AI agent 306 may generate a UCI for a buyer. UCIs may be stored in UCI decentralized database 308.

A second AI agent 310 may respond to a trade request from a buyer. AI agent 310 may generate a query based on a UCI extracted from a buyer request. AI agent 310 may generate a query based on parameters extracted from the buyer request. AI agent 310 may generate a query based on parameters predicted based on the buyer UCI or buyer request.

AI agent 310 may interact with AI agent 306 to retrieve a set of seller UCIs for sellers that are compatible with the buyer request. In some embodiments, AI agent 310 may interact directly with UCI database 308 to retrieve seller UCIs. AI agent 310 may optimize the query to quickly and efficiently search a large amount of data.

AI agent 310 may generate a query associated with a seller UCI. AI agent 310 may interact with a third AI agent 312. AI agent 312 may interface with multiple cryptocurrency exchanges. Process flow 300 shows a first cryptocurrency exchange 314 associated with seller 318, and a second cryptocurrency exchange 316. Exchange 316 may be associated with buyer 302 or bank 304.

AI agent 312 may connect AI agent 310 with exchange 314 to execute a query. In some embodiments, AI agent 312 may execute the query generated by AI agent 310 at exchange 314. The query may retrieve past activity for seller 318 at exchange 314. The query may analyze the past activity for seller 318 and output a security level for seller 318.

AI agent 312 may interface with buyer 302 and seller 318. In some embodiments, AI agent 312 may interface with buyer 302 at bank 304. AI agent 312 may display a list of compatible sellers to buyer 302. Compatibility may be based on trade parameters, security level, market factors, and/or any suitable factor. In some embodiments, AI agents 310 or 312 may be configured to return only sellers with trade parameters above a threshold percentage match or with a security level below a predetermined threshold. In some embodiments the thresholds may be determined based on predicted buyer preferences. In some embodiments, the thresholds may be determined and/or adjusted by a system administrator, financial institution, or individual buyer. AI agent 312 may display a security level associated with each seller. AI agent 312 may rank the sellers based on security level or based on any suitable factors.

In response to input from buyer 302 selecting seller 318 and input from seller 318 accepting the trade, AI agent 312 may initiate a cryptocurrency transfer. In some embodiments, the buyer or the seller may initiate the transaction using a private key.

AI agent 312 may confirm execution of the transfer with exchange 314 and exchange 316. AI agent 312 may confirm execution of the transfer with buyer 302, seller 318, and bank 304.

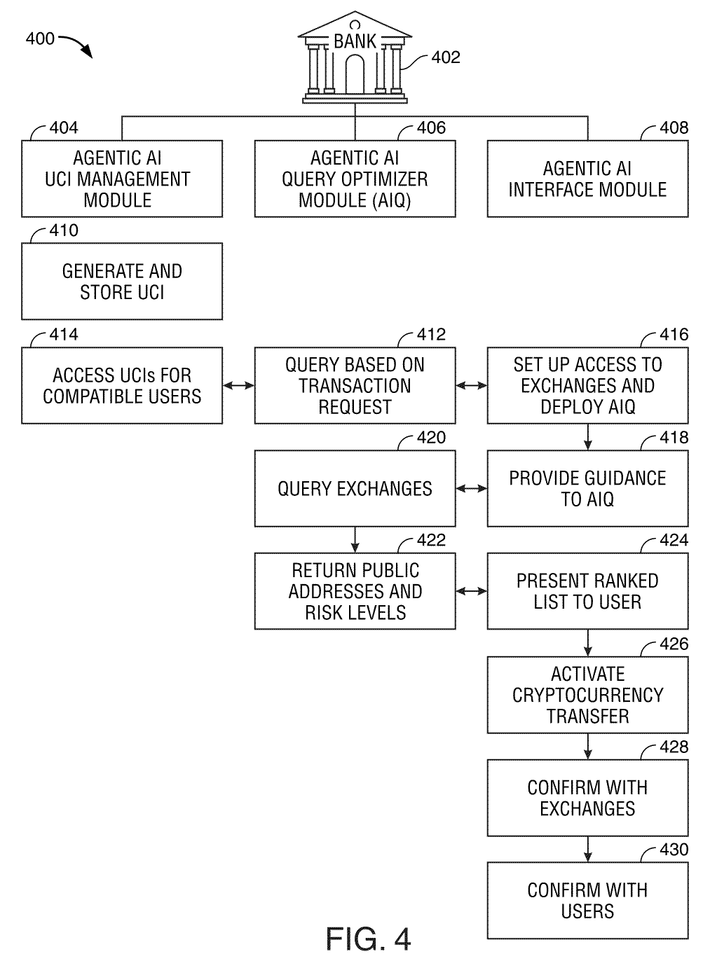

FIG. 4 shows illustrative process flow 400 for agentic AI architecture for securing cross-exchange activity. Bank 402 may manage an API that deploys a set of cooperative AI agents. The AI agents may detect issues associated with a trade and may act independently to resolve them.

The agentic AI architecture may include UCI management module 404. At 410, UCI management module 404 may generate a UCI for a buyer or seller and store the UCI in a decentralized database. UCI management module 404 may use a hash function or any suitable encryption method to generate the UCI. The buyer or seller may be a client of bank 402. Bank 402 may initiate assignment of a UCI for clients holding cryptocurrency assets.

The agentic AI architecture may include agentic AI query optimizer module (AIQ) 406. Bank 402 may receive a cryptocurrency trade request from a client. At 412, AIQ 406 may extract features from the trade request and generate a query. At 414, based on the query, UCI management module 404 may return UCIs and public address for compatible transaction partners.

The agentic AI architecture may include agentic AI interface (AII) module 408. At 416, AII 408 may interface with exchanges associated with the returned UCIs. At 418, AII may provide guidance to refine a query generated at AIQ 406. The query may be formulated to retrieve past activity associated with a UCI. The guidance may include data associated exchange structures that may be applied to optimize the query. At 420, AII 408 may deploy AIQ 406 to an exchange to execute the query. Alternatively, AII 408 may execute the query generated at AIQ 406 at the exchange.

At 422, the AIQ may return identity data for each UCI. The AIQ may output a security level associated with each identity. At 424, the AII may interface with a buyer or seller and may present a ranked list of identities and security levels for potential transaction partners.

At 426, in response to inputs from the parties, the AII may activate a cryptocurrency transfer. At 428, the AII may confirm transaction execution at the buyer and seller exchanges. At 430, the AII may confirm transaction execution with the buyer and seller.

Thus, methods and apparatus for AGENTIC AI ARCHITECTURE FOR CROSS-EXCHANGE SECURITY are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for cross-exchange interaction at an agentic artificial intelligence (AI) system, the method comprising, at an application programming interface (API) comprising a set of AI agents:
at a first AI agent:
using a hash function, generating a universal cryptocurrency identifier (UCI) associated with a public address; and
storing the UCI in a decentralized database in association with the public address;
at a second AI agent:
at a first cryptocurrency exchange:
extracting a buyer UCI from a buyer request; and
generating a query based on predicted trade parameters, the trade parameters based at least in part on the buyer UCI;
at the decentralized database, executing the query and retrieving a seller UCI and a public address associated with the seller UCI;
at a second cryptocurrency exchange, executing the query and retrieving past activity associated with the seller UCI; and
based on the past activity at the second cryptocurrency exchange, outputting a security level associated with the seller;
confirming execution of the transfer to the buyer and the first cryptocurrency exchange; and
confirming execution of the transaction to the seller and the second cryptocurrency exchange.

2. The method of claim 1, the second AI agent comprising a large language model and the buyer request comprising a natural language prompt.

3. The method of claim 1, further comprising, at the second AI agent, optimizing the query based on at least one feature of the second cryptocurrency exchange to improve search speed.

4. The method of claim 1, further comprising, at the third AI agent, generating a ranked list of sellers based at least in part on output from the second AI agent.

5. The method of claim 1, further comprising, at the third AI agent:
outputting a set of actions based on a security level associated with a seller; and
in response to input from a buyer selecting the seller, implementing the set of actions.

6. The method of claim 1, wherein a security level is based on a change in location for the seller.

7. The method of claim 1, wherein a security level is based on a change in device metadata associated with the seller.

8. One or more non-transitory computer-readable media storing computer-executable instructions which, when executed by a processor on a computer system, perform a method for secure cross-exchange interaction, the method comprising, at an application programming interface (API) comprising a set of artificial intelligence (AI) agents:
using a hash function, generating a first universal cryptocurrency identifier (UCI) for a buyer, the UCI associated with a first public address, and storing the first UCI in a decentralized database in association with the first public address;
using the hash function generating a second UCI for a seller, the UCI associated with a second public address, and storing the second UCI in the decentralized database in association with the second public address;
at a first cryptocurrency exchange:
extracting the first UCI from a buyer request; and
generating a query based on predicted trade parameters, the trade parameters based at least in part on the first UCI;
executing the query at the decentralized database and retrieving the second UCI and second public address;
executing the query at a second cryptocurrency exchange and retrieving past activity associated with the second UCI;
based on the past activity at the second cryptocurrency exchange, outputting a security level associated with the seller;
interfacing with the buyer at the first cryptocurrency exchange and the seller at the second cryptocurrency exchange;
displaying a set of sellers and security levels to the buyer;
in response to input by the buyer selecting a seller, initiating a cryptocurrency transfer using a private key;
in response to execution of the cryptocurrency transfer:
confirming execution of the transaction to the buyer and the first cryptocurrency exchange; and
confirming execution of the transaction to the seller and the second cryptocurrency exchange.

9. The media of claim 1, the method further comprising optimizing the query based on at least one feature of the second cryptocurrency exchange to improve search speed.

10. The media of claim 1, the method further comprising generating a ranked list of sellers based at least in part on the security levels for each seller.

11. The media of claim 8, the method further comprising:
outputting a set of actions based a on a security level associated with a seller; and
in response to input from a buyer selecting the seller, implementing the set of actions.

12. The media of claim 8, wherein a security level is based on a change in location for the seller.

13. The media of claim 8, wherein a security level is based on a change in device metadata associated with the seller.

14. The media of claim 11, the method further comprising generating a smart contract comprising a buyer specification and an action selected by the seller from the set of actions based on the security level.

15. The media of claim 14, wherein the cryptocurrency transfer comprises execution of the smart contract.

16. An agentic artificial intelligence (AI) system for cross-exchange interaction, the system comprising a processor running an application programming interface (API) comprising:
a first AI agent configured to:
using a hash function, generate a universal cryptocurrency identifier (UCI) associated with a public address; and
store the UCI in a decentralized database in association with the public address;
a second AI agent configured to:
at a first cryptocurrency exchange:
extract a buyer UCI from a buyer request; and
generate a query based on predicted trade parameters, the trade parameters based at least in part on the buyer UCI;
execute the query at the decentralized database and retrieve a seller UCI and a public address associated with the seller UCI;
execute the query at a second cryptocurrency exchange and retrieve past activity associated with the seller UCI; and
based on the past activity at the second cryptocurrency exchange, output a security level associated with the seller;
confirm execution of the transfer to the buyer and the first cryptocurrency exchange; and
confirm execution of the transfer to the seller and the second cryptocurrency exchange.

17. The system of claim 16, the second AI agent further configured to optimize the query based on at least one feature of the second cryptocurrency exchange to improve search speed.

18. The system of claim 16, the third AI agent further configured to generate a ranked list of sellers based at least in part on output from the second AI agent.

19. The system of claim 16, the third AI agent further configured to:
output a set of actions based on a security level associated with a seller; and
in response to input from a buyer selecting the seller, implementing the set of actions.

20. The system of claim 16, the third AI agent further configured to generate a smart contract comprising a buyer specification and an action selected by the seller from the set of actions based on the security level.

21. The system of claim 20, wherein the cryptocurrency transfer comprises execution of the smart contract.
